(19) United States
(12) Patent Application Publication
(10) Pub. No.: US 2011/0279001 A1
(43) Pub. Date: Nov. 17, 2011

(54) ENCLOSED FRONT PERSONAL PROTECTION EQUIPMENT ORGANIZER

(76) Inventors: William P. Peters, Weldon Springs, MO (US); Edward H. Ruble, Wentzville, MO (US)

(21) Appl. No.: 12/781,440

(22) Filed: May 17, 2010

(51) Int. Cl. A47B 81/00; F16M 13/02

(52) U.S. Cl. 312/209; 248/205.1

(57) ABSTRACT

A cabinet is described that includes a back member, a plurality of side members extending from the back member to form a substantial enclosure, and at least one front member movable with respect to the side members from a first position to a second position. Each front member has a front surface and a back surface where the back surface is adjacent the side members in the first position. Each front member includes at least one opening extending therethrough and at least one bracket system attached to the back surface. Each bracket system is associated with one of the openings, and is operable for retaining a container of personal protection equipment, the container accessible through the opening for extraction of a personal protection equipment item from the container.

### BACKGROUND OF THE INVENTION

The field of the invention relates generally to shelving devices, and more specifically to a shelving apparatus which is especially useful in the medical office and hospital environment.

Today's medical office and hospital environment includes an extraordinary amount of personal protection equipment including, but not limited to, examination gloves, face masks, protection gowns, and hand wash along with the traditional medical supplies including bandages of varying sizes and topically applied treatments, for example, alcohol wipes, ointments, and other cleansing solutions. Traditionally, at least some of these products are prepackaged, for example, with 100 bandages in a box or 50 alcohol wipes in a dispenser. These prepackaged products have been stored for usage in a cabinet or on a counter. However, with the ever increasing amount of such medical supplies, cabinet and counter space is at a premium. In addition, due to ever increasing time constraints being placed on medical practitioners, convenience and ease of access is becoming more important. However, aesthetics are also important. Devices for housing personal protection equipment should be presented in such a way that they enhance the space in which they are mounted rather than be a distraction or be aesthetically unpleasing.

### BRIEF DESCRIPTION OF THE INVENTION

In one aspect, a cabinet is provided that includes a back member, a plurality of side members extending from the back member to form a substantial enclosure, and at least one front member movable with respect to the side members from a first position to a second position. Each front member has a front surface and a back surface where the back surface is adjacent the side members in the first position. Each front member includes at least one opening extending therethrough and at least one bracket system attached to the back surface. Each bracket system is associated with one of the openings, and is operable for retaining a container of personal protection equipment, the container accessible through the opening for extraction of a personal protection equipment item from the container.

In another aspect, a front member for an enclosed personal protection equipment organizer is provided. The front member includes a front surface, a back surface, at least one opening extending therethrough, and at least one device attached to the back surface for placement of personal protection equipment (PPE) therein such that the PPE is adjacent the back surface and can be accessed through the at least one opening.

### BRIEF DESCRIPTION OF THE DRAWINGS

FIG. 1 is a perspective view of an enclosed front personal protection equipment (PPE) organizer with the front members in a first position.

FIG. 2 is an illustration of the PPE organizer of FIG. 1 with the front members in a second position.

FIG. 3 is an illustration of a front member for the PPE organizer of FIG. 1 including a detail view of the back surface.

FIG. 4 is an illustration of a bracket including a top member and a bottom member which attach to the back surface of the front member of FIG. 3.

FIG. 5 is an illustration of the top and bottom members of the bracket of FIG. 4 detailing movement of the members with respect to the back surface of the front member of FIG. 3.

FIG. 6 is an illustration of a ratcheting system for adjusting a position of the top and bottom members of the bracket of FIG. 4 with respect to the back surface of the front member of FIG. 3.

FIG. 7 is an illustration of a gown bin for attachment to a back surface of a front member of a PPE organizer.

FIG. 8 is an illustration of an enclosed front PPE organizer, similar to the PPE organizer of FIG. 1 that includes a flange about a perimeter thereof allowing for in wall installation.

FIG. 9 is an illustration of an enclosed front PPE organizer with the front members vertically oriented with respect to one another.

FIG. 10 is an illustration of an enclosed front PPE organizer with the front members vertically oriented with respect to one another similar to the PPE organizer of FIG. 9 that includes a flange about a perimeter thereof allowing for in wall installation.

### DETAILED DESCRIPTION OF THE INVENTION

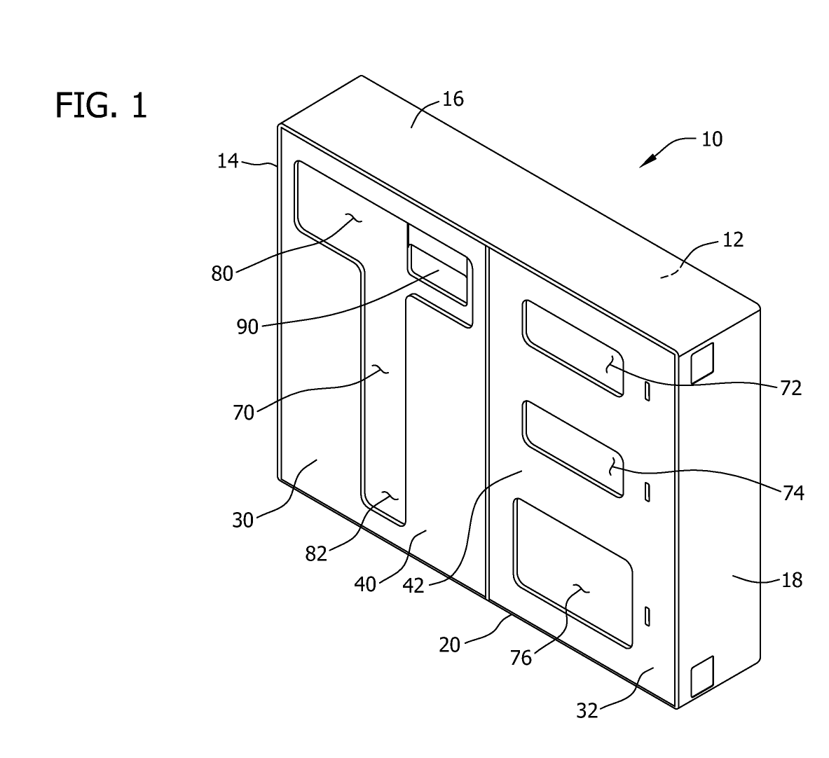

FIG. 1 is a perspective view of an enclosed front personal protection equipment (PPE) organizer 10, which is sometimes referred to herein as a cabinet. PPE organizer 10 includes a back member 12, and a plurality of side members 14, 16, 18, and 20 extending from back member 12 to form a substantial enclosure. PPE organizer 10 further includes front members 30 and 32 which are movable with respect to side members 14, 16, 18, and 20 from a first position to a second position. In the illustrated embodiment, two front members 30 and 32 are shown, but embodiments are contemplated that include a single front member as well as embodiments that include more than two front members.

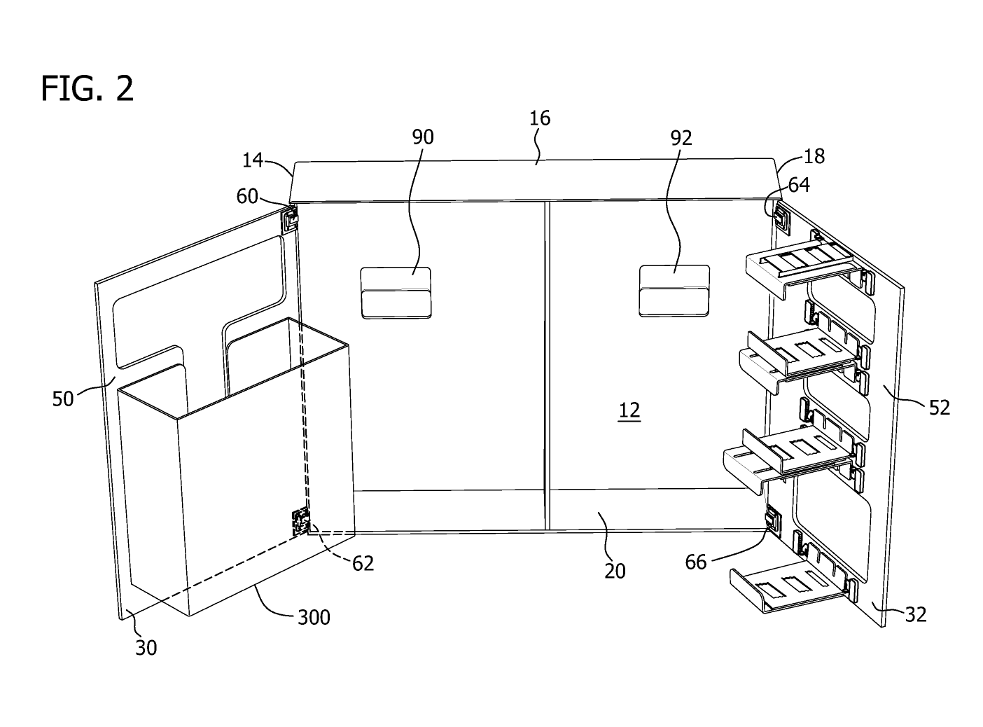

FIG. 1 illustrates front members 30 and 32 in the first position, while FIG. 2 is an illustration of PPE organizer 10 with the front members 30 and 32 in a second position. As is seen in FIG. 2, front members 30 and 32 have a front surface 40 and 42 respectively, and a back surface 50 and 52 respectively. When front members 30 and 32 are in the first position, the back surfaces 50 and 52 are adjacent side members 14, 16, 18, and 20. In the illustrated embodiment, for moving front members 30 and 32 with respect to side members 14, 16, 18, and 20, PPE organizer 10 includes a hinging system made up of hinges 60, 62, 64, and 66 attaching front members 30 and 32 to respective side members 14 and 18.

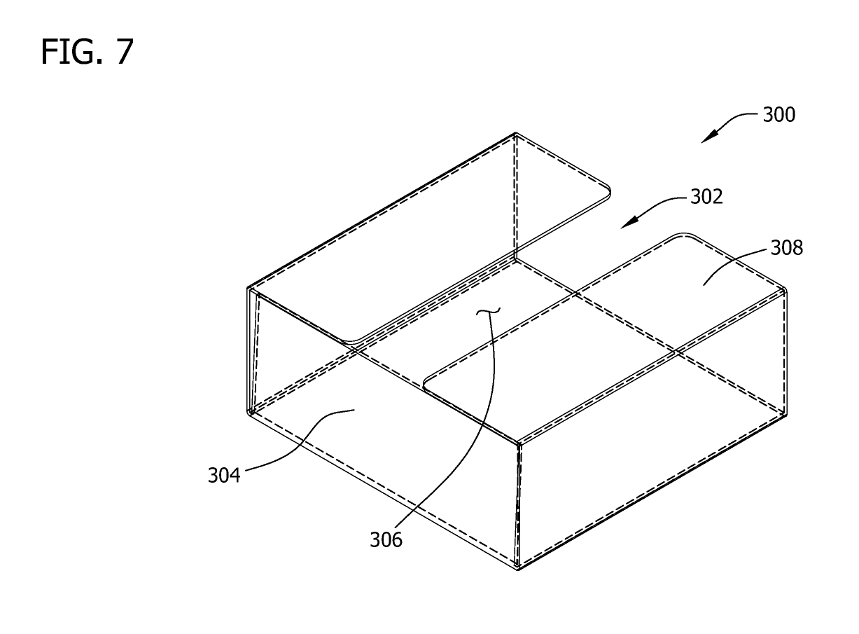

Front members 30 and 32 are configured to include openings that extend therethrough. While those skilled in the art will realize that multiple configurations are possible, the embodiment illustrated in FIGS. 1 and 2 includes a T-shaped opening 70 in front member 30 and substantially rectangular openings 72, 74, and 76 in front member 32. T-shaped opening 70 includes a horizontal portion 80 and a vertical portion 82 which, as explained in the following paragraphs, are useful for accessing a disposable gown stored within a gown bin 300 (described with respect to FIG. 7) that forms a portion of PPE organizer 10.

FIG. 2 also illustrates a number of mounting openings 90 and 92 formed in the back member 12 which are operable for engaging with corresponding wall mounting members (not shown in FIG. 2).

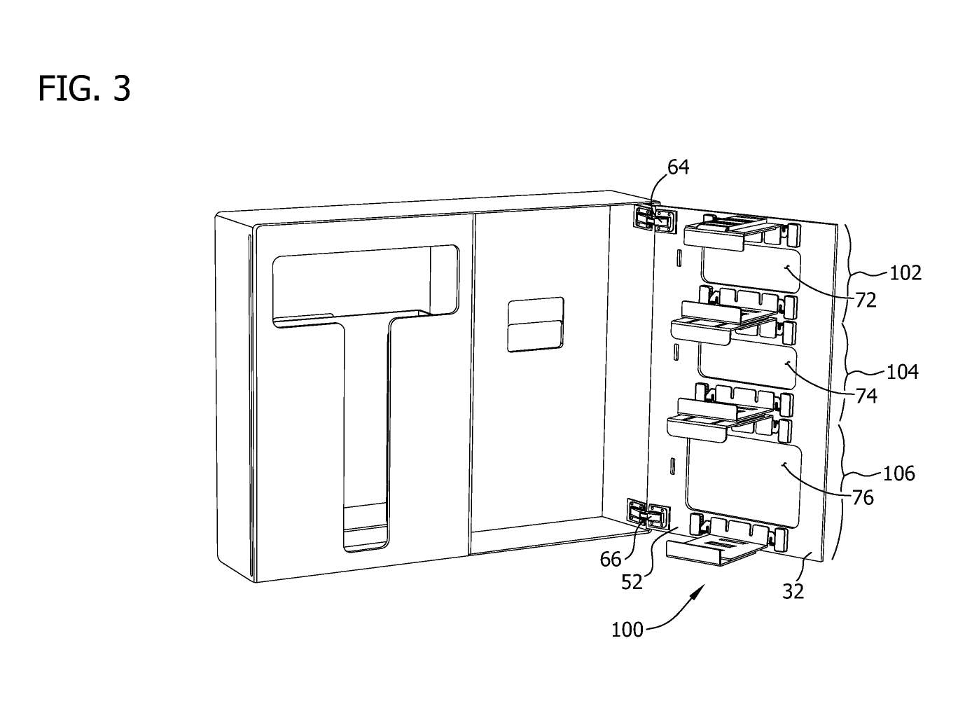

FIG. 3 is an illustration of front member 32 providing detail associated with back surface 52. Specifically, bracket systems 100 are attached to the back surface 52 and each instance of bracket system 100, specifically individual brackets 102, 104, and 106 is associated with a corresponding opening 72, 74, and 76 respectively. Each bracket system 100, as explained further herein, is operable for retaining a container of personal protection equipment, the container accessible through the corresponding opening for extraction of a personal protection equipment item from the container.

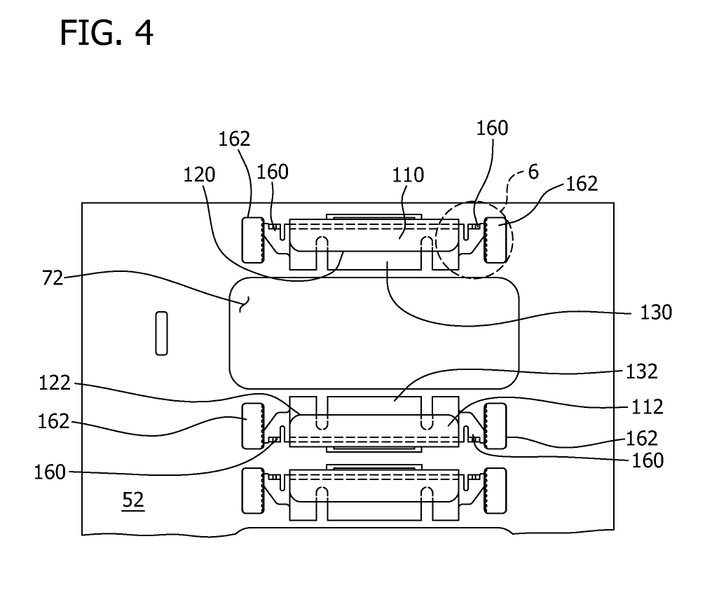

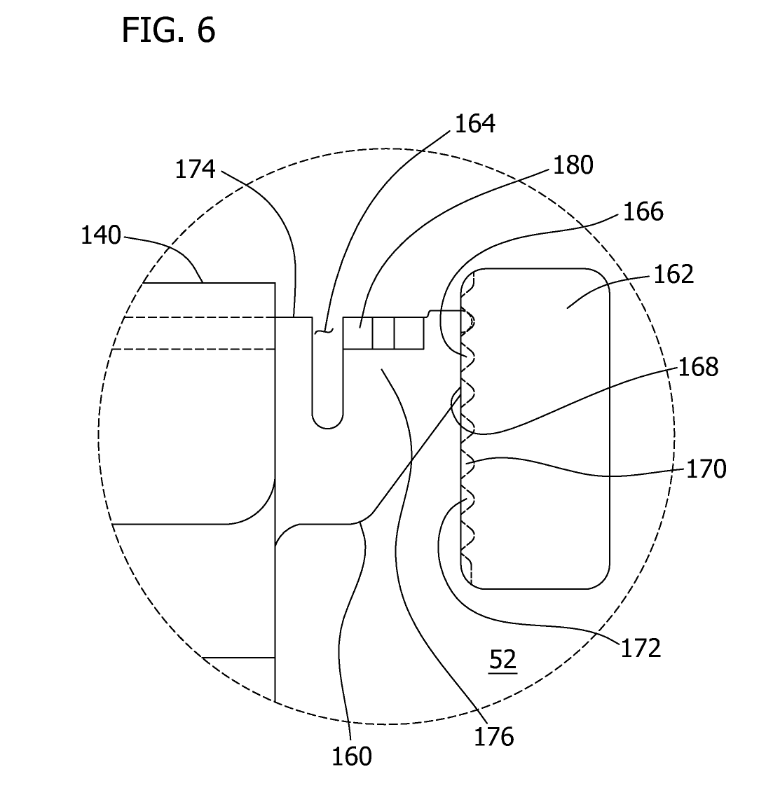

Continuing, FIG. 4 is a detailed illustration of bracket 102 which includes a top member 110 and a bottom member 112. As described further herein, a distance between top member 110 and bottom member 112 is adjustable and described with respect to FIG. 6. Top member 110 and bottom member 112 each include a retention lip 120 and 122 respectively extending at a substantial normal angle from the respective members for retaining a container of personal protection equipment between the retention lips 120 and 122 and the back surface 52 of front member 32. In addition, and related to the adjustable distance between top member 110 and bottom member 112, the top member 110 and bottom member 112 further include an attachment lip 130 and 132 respectively extending at a substantial normal angle therefrom for attaching top member 110 and bottom member 112 to back surface 52 of front member 32.

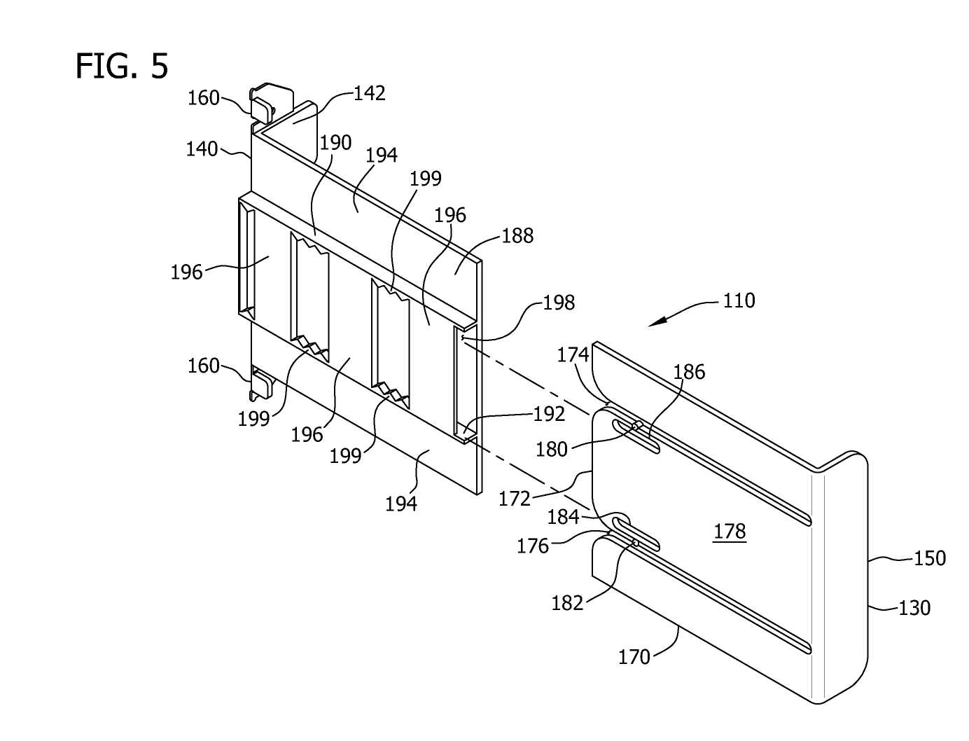

Referring to FIG. 5, a distance between retention lip 120 and attachment lip 130 is adjustable as top member 110 is fabricated from two separate components, back surface attachment member 140 and container engagement member 150 that are slidably engageable with one another. Back surface attachment member 140 includes attachment lip 130 and container engagement member 150 includes retention lip 120. Similarly, a distance between retention lip 122 and attachment lip 132 is adjustable as bottom member 112 is also fabricated from two separate components, a back surface attachment member and container engagement member that are slidably engageable with one another and include a plurality of locking positions for maintaining a specific position of container engagement member with respect to the corresponding back surface attachment member.

As mentioned above, a distance between top member 110 and bottom member 112 is adjustable. A ratcheting member 160 extends laterally outward from each side of the back surface attachment members to be in movable engagement with a corresponding support member 162 permanently attached to (or formed integrally with) back surface 142. In use, one or both of a top member 110 and a bottom member 120 are moved vertically with respect to support member 162, such that the ratcheting member 160 engages the support member 162 in a different area. A detailed embodiment of ratcheting member 160 and support member 162 is shown in FIG. 6.

Continuing, FIG. 5 is a perspective view of surface attachment member 140 and container engagement member 150 which may be utilized with front member 32. Extending along a length of a body portion 170 of container engagement member 150, from end 172, are two slots 174 and 176 spaced a distance apart thereby forming an inner tray tongue 178 between slots 174 and 176. Inner tray tongue 178 includes one or more protrusions 180 and 182 extending therefrom and into respective slots 174 and 176 which help to secure a position of container engagement member 150 with respect to back surface attachment member 140. In the embodiment, inner tray tongue 178 is further configured with one or more openings 184 and 186 formed therein that are substantially adjacent protrusions 180 and 182. Based on a flexibility of the material from which container engagement member 150 is formed, openings 184 and 186 in inner tray tongue 178 allow protrusions 180 and 182 to retract somewhat when engaging surface attachment member 140. Protrusions 180 and 182 provide at least a portion of a position retaining device when surface attachment member 140 is engaged with container engagement member 150.

Surface attachment member 140 is configured to engage container engagement member 150 to form a top member 110 (or a bottom member 112) of a bracket. The other top members as well as the other bottom members are substantially the same and top member 110 should be construed as but one example of such brackets.

Surface attachment member 140 is a substantially “L” shaped member including a body portion 188 and back surface attachment member 142. Surface attachment member 140 includes rails 190 and 192 extending from an underside 194 of body portion 188. A plurality of perpendicular members 196 extend between rails 190 and 192 forming a channel 198 bordered by a portion of body portion 188, rails 190 and 192 and perpendicular members 196. Channel 198 is thus configured for insertion of inner tray tongue 178. An area of rails 192 between respective perpendicular members 196 is configured as a series of triangular (or another shape) notches 199 configured to engage protrusions 180 and 182 of container engagement member 150 providing detent positions as surface attachment member 140 and container engagement member 150 engage one another as above described allowing a user to create desired length for a bracket.

As mentioned above, a distance between top member 110 and bottom member 112 is adjustable. One embodiment for adjusting the distance is shown in FIG. 6. Specifically, a ratcheting member 160 extends laterally outward from each side of the back surface attachment members 140 to be in movable engagement with a corresponding support member 162 permanently attached to (or formed integrally with) back surface 52. In use, one or both of a top member 110 and a bottom member 120 are moved vertically with respect to the corresponding support member 162, such that the ratcheting member 160 engages the support member 162 in a different area.

To enable such movement, ratcheting member 160 is formed to include a collapsing slot 164 therein. Ratcheting member 160 further includes a plurality of teeth 166 along a side 168 thereof. The teeth 166 engage opposing teeth 170 that are formed on a side 172 of the support member 162. A base member 174 and a flexible arm 176 are on opposite sides of the collapsing slot 164, and the teeth 166 extend from the flexible arm 176. In one embodiment, a force is applied to the top or bottom member to the point where the flexible arm 176 compresses into collapsing slot 164 allowing the teeth 166 to disengage from their current position with respect to the respective support members 162 and reengage opposing teeth 170 at another position. In another embodiment, a user handle 180 extends normally from flexible arm 176 allowing the user to compress the flexible arm 176 into the collapsing slot 164 and move the member up or down with respect to the support member. The user releases the user handle 180 and the teeth 166 are allowed to reengage the opposing teeth 170, though at a different position. In either embodiment, ratcheting member 160 is fabricated from a material, such as a plastic, that is flexible under pressure, but that returns to an original position upon a release of the pressure.

FIG. 7 is an illustration of a gown bin 300 for attachment to back surface 50 of front member 30, the attachment being proximate T-shaped opening 70 as further explained. Gown bin 300 is a substantial container having a substantially rectangular cross-section. Gown bin 300 includes a substantially rectangular top opening 302 which is useful for insertion of gowns (not shown in FIG. 6) into gown bin 300. When gown bin 300 attached to back surface 50, the top opening 302 is proximate an intersection of the horizontal portion 80 and vertical portion 82 of the T-shaped opening 70. Gown bin 300 also includes a bottom surface 304 upon which the aforementioned gowns are stacked. The bottom surface 304 is proximate a bottom of vertical portion 82 of T-shaped opening 70 when gown bin 300 is mounted on back surface 50 of front member 30.

Gown bin 300 also includes a vertical opening 306 formed in a front surface 308 thereof. When gown bin 300 is mounted on back surface 50 of front member 30, vertical opening 306 substantially aligned with the vertical portion 82 of T-shaped opening 70. The arrangement of gown bin 300, vertical opening 306, and T-shaped opening 70 is useful for the storage of, and access to, disposable medical gowns stored in gown bin 300. When gown bin 300 is full or nearly full a person can reach through the horizontal portion 80 of T-shaped opening 70 to obtain a gown in gown bin 300. When a supply of gowns within gown bin 300 is close to being depleted, a person can reach through the aligned vertical opening 306 of gown bin 300 and vertical portion 82 of T-shaped opening 70 to grab a gown. For removal from gown bin 300, the user simply lifts the gown along the aligned vertical opening 306 and vertical portion 82 until the gown is proximate horizontal portion 80 of T-shaped opening 70, upon which the user extracts the gown through the horizontal portion 80 of T-shaped opening 70.

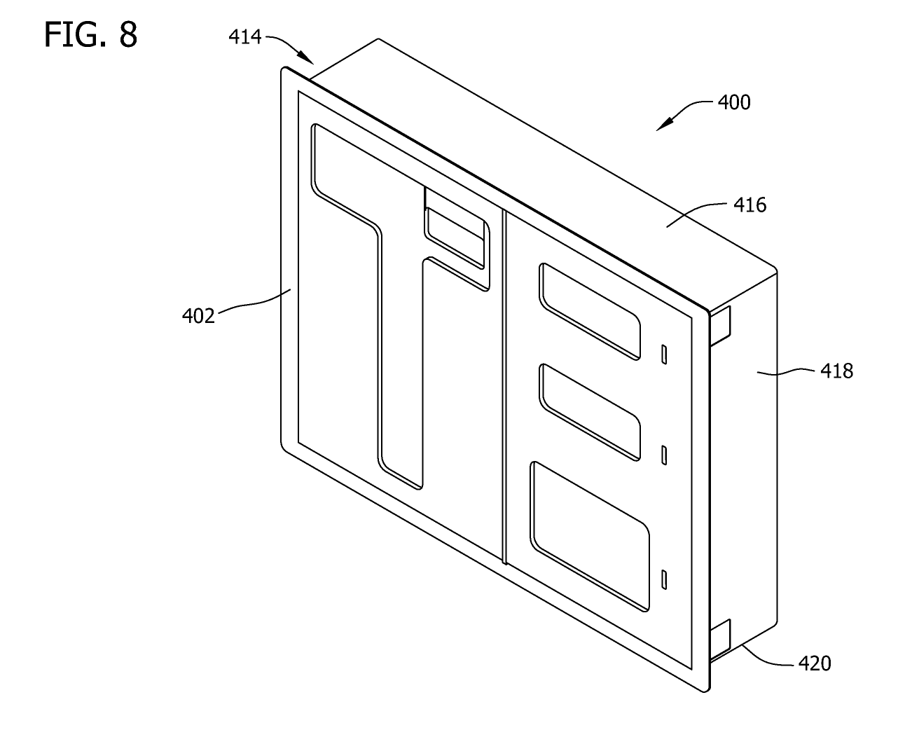

FIG. 8 is an illustration of an enclosed front PPE organizer 400, similar to the PPE organizer 10 of FIG. 1. PPE organizer 400 includes a flange 402 that extends about a perimeter defined by, and extending substantially normal from side members 414, 416, 418, and 420 thereof allowing for in wall installation. The remaining features of PPE organizer 400 are the same as those associated with PPE organizer 10.

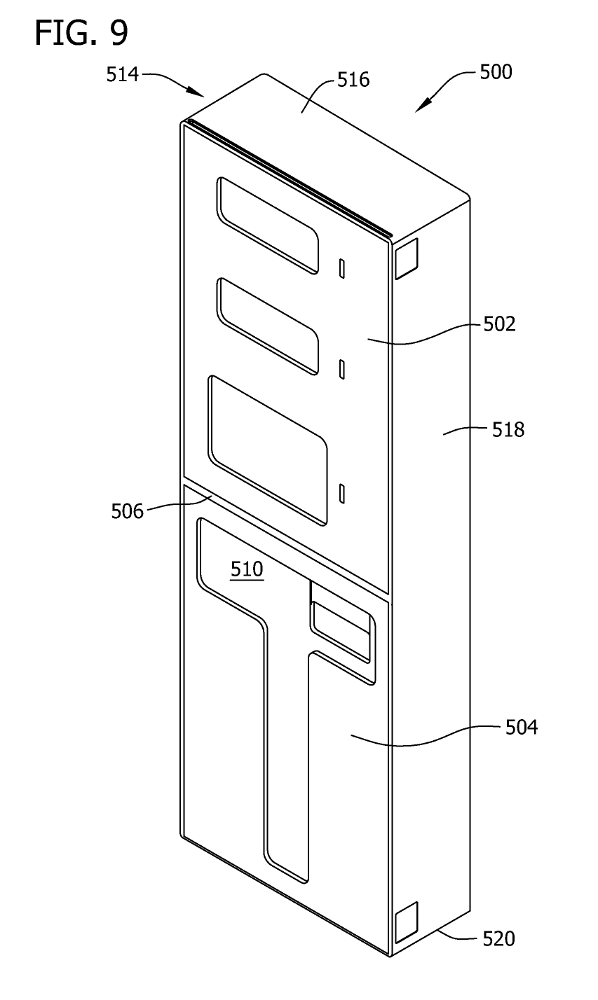

FIG. 9 is an illustration of an enclosed front PPE organizer 500 with the front members 502 and 504 vertically oriented with respect to one another. A horizontal panel 506 is formed within the substantial enclosure defined by the back member 510 and the side members 514, 516, 518, and 520 for structural integrity and to provide separation between front members 502 and 504. Otherwise, the PPE organizer 500 is configured in the same manner as PPE organizer 10.

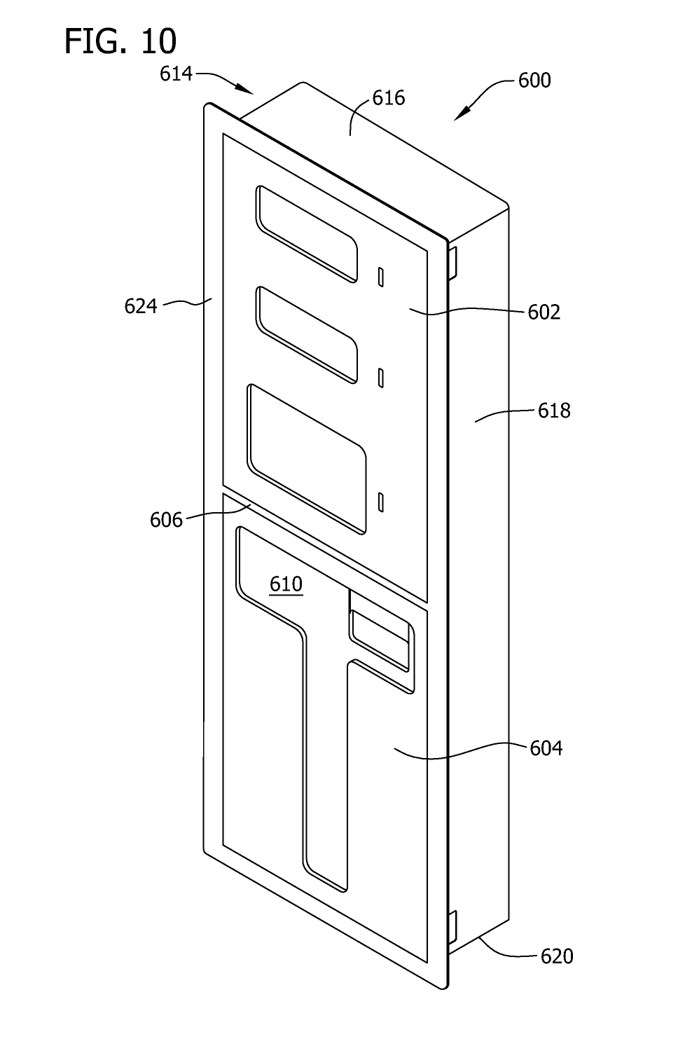

FIG. 10 is an illustration of an enclosed front PPE organizer 600 with the front members 602 and 604 vertically oriented with respect to one another. A horizontal panel 606 is formed within the substantial enclosure defined by the back member (not shown) and the side members 614, 616, 618, and 620 for structural integrity and to provide separation between front members 602 and 604. PPE organizer 600 further includes a flange 624 about a perimeter thereof allowing for in wall installation.

While the above figures illustrate enclosed front PPEs that incorporate hinges, embodiments are contemplated that utilize other devices for movably mounting front members to the remainder of the PPE. In one specific embodiment, drawer rails are incorporated for moving the front members from a first position to a second position and back with respect to the side members. Drawer rails 702 may be incorporated in place of hinges in any of the embodiments described herein.

The PPE organizers described herein provide an aesthetically pleasing appearance as well as serve a functional need for the accessible storage of PPE such as gloves, gowns, and masks. Replenishment of the PPE organizers is accomplished by simply moving the respective front member to a second position, where a user can simply install the container of PPE in the correct position proximate the respective opening in the front member. The configuration of brackets and gown bins on the back surface of a front member is an improvement over known configurations as such brackets and bins insure that the PPE containers, and the openings therein are properly aligned with the openings through the front members. With respect to gowns, the T-shaped opening allows for easy access no matter how full of gowns the bin is. Further, gowns are easily replenished by simply moving the appropriate front members and placing a container holding a number of the gowns into the bin. Gowns not in a container can also be easily placed into the gown bin and be easily accessed and removed, one at a time, by users of such gowns.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A cabinet comprising:
a back member;
a plurality of side members extending from said back member to form a substantial enclosure; and
at least one front member movable with respect to said side members from a first position to a second position, said at least one front member comprising a front surface and a back surface, said back surface adjacent said side members in the first position, said at least one front member further comprising:
at least one opening extending therethrough;
at least one bracket system attached to said back surface, each said bracket system associated with a said opening, each said bracket system operable for retaining a container of personal protection equipment, the container accessible through said opening for extraction of a personal protection equipment item from the container.

2. A cabinet according to claim 1 wherein for moving said at least one front member with respect to said side members, said cabinet further comprises at least one of a hinge system attaching said front members to respective said side members, and a drawer rail system attaching said front members to respective said side members.

3. A cabinet according to claim 1 wherein each said bracket system comprises a top member and a bottom member attached to said back surface.

4. A cabinet according to claim 3 wherein a distance between said top member and said bottom member is adjustable.

5. A cabinet according to claim 3 wherein said top member and said bottom member each comprise a retention lip extending at a substantial normal angle therefrom for retaining a container of personal protection equipment between said retention lips and said back surface of said front member.

6. A cabinet according to claim 3 wherein said top member and said bottom member each comprise an attachment lip extending at a substantial normal angle therefrom for attaching said top member and said bottom member to said back surface of said front member.

7. A cabinet according to claim 3 wherein:
said top member and said bottom member each comprise a retention lip extending at a substantial normal angle therefrom for retaining a container of personal protection equipment between said retention lips and said back surface of said front member;
said top member and said bottom member each comprise an attachment lip extending at a substantial normal angle therefrom for attaching said top member and said bottom member to said back surface of said front member; and
a distance between said retention lip and said attachment lip is adjustable.

8. A cabinet according to claim 1 wherein said back member comprises at least one mounting opening therein operable for engagement with corresponding wall mounting members.

9. A cabinet according to claim 1 wherein one of said openings comprises a T-shaped opening comprising a horizontal portion and a vertical portion.

10. A cabinet according to claim 9 further comprising a gown bin for attachment to said back surface proximate said T-shaped opening, said gown bin comprising a top opening for insertion of gowns into said bin, said top opening proximate an intersection of said horizontal portion and said vertical portion of said T-shaped opening when said gown bin is mounted on said back surface of said front member.

11. A cabinet according to claim 10 wherein:
said gown bin comprises a bottom surface opposite said top opening, said bottom surface proximate a bottom of said vertical portion of said T-shaped opening when said gown bin is mounted on said back surface of said front member; and
said gown bin comprises a vertical opening formed in a front surface thereof, said vertical opening substantially aligned with said vertical portion of said T-shaped opening when said gown bin is mounted on said back surface of said front member.

12. A cabinet according to claim 3 wherein said top member and said bottom member each comprise:
a back surface attachment member; and
a container engagement member slidably engageable with said back surface member, the slidable engagement comprising a plurality of locking positions for maintaining a specific position of said container engagement member with respect to the corresponding said back surface attachment member.

13. A cabinet according to claim 3 further comprising:
a ratcheting member extending laterally outward from each side of said top member and said bottom member; and
a plurality of support members adjacent said back surface, each support member corresponding to a side of one of said top member and said bottom member, each said ratcheting member in movable engagement with the corresponding said support member.

14. A cabinet according to claim 13 wherein said ratcheting member is formed to include a plurality of teeth along a side thereof operable for engagement with opposing teeth formed on a side of said support member.

15. A cabinet according to claim 13 wherein said ratcheting member comprises:
a base member;
a flexible arm; and
a collapsing slot between said base member and said flexible arm such that said flexible arm may be compressed into said collapsing slot to enable movement of said ratcheting member with respect to said support member.

16. A front member for an enclosed personal protection equipment organizer, said front member comprising:
a front surface;
a back surface;
at least one opening extending therethrough; and
at least one device attached to said back surface for placement of personal protection equipment (PPE) therein such that the PPE is adjacent said back surface and can be accessed through said at least one opening.

17. A front member according to claim 16 wherein said at least one device comprises a bracket system attached to said back surface and associated with one of said openings, said bracket system comprising:
a top member attached to said back surface;
a bottom member attached to said back surface, a distance between said top member and said bottom member being adjustable.

18. A front member according to claim 17 said top member and said bottom member each comprise:
a retention lip extending at a substantial normal angle therefrom for retaining a container of personal protection equipment between said retention lips and said back surface of said front member; and
an attachment lip extending at a substantial normal angle therefrom for attaching said top member and said bottom member to said back surface of said front member.

19. A front member according to claim 18 wherein said top member and said bottom member each comprise:
a back surface attachment member, said attachment lip extending therefrom; and
a container engagement member slidably engageable with said back surface member, the slidable engagement comprising a plurality of locking positions for maintaining a specific position of said container engagement member with respect to the corresponding said back surface attachment member, said retention lip extending therefrom.

20. A front member according to claim 18 wherein:
said attachment lip comprises a ratcheting member extending laterally outward from each side thereof; and
said back surface comprises a plurality of support members extending therefrom, each support member corresponding to a respective said ratcheting member to provide movable engagement therebetween.

21. A front member according to claim 20 wherein:
said ratcheting member is formed to include a plurality of teeth along a side thereof; and
said support member is formed to include a plurality of teeth along a side thereof, said teeth operable to engage said ratcheting member teeth and operable to provide the movable engagement between said ratcheting member and said support member.

22. A front member according to claim 21 wherein said ratcheting member comprises:
a base member;
a flexible arm; and
a collapsing slot between said base member and said flexible arm such that said flexible arm may be compressed into said collapsing slot upon application of a force to remove engagement of said ratcheting member teeth and said support member teeth, removal of the force allowing said flexible arm to return to a first position such that said ratcheting member teeth and said support member teeth may reengage.

23. A front member according to claim 16 wherein:
at least one said opening comprises a T-shaped opening comprising a horizontal portion and a vertical portion; and
said at least one device comprises a gown bin for attachment to said back surface proximate said T-shaped opening, said gown bin comprising a top opening for insertion of gowns into said bin, said top opening proximate an intersection of said horizontal portion and said vertical portion of said T-shaped opening when said gown bin is mounted on said back surface of said front member.

24. A front member according to claim 23 wherein:
said gown bin comprises a bottom surface opposite said top opening, said bottom surface proximate a bottom of said vertical portion of said T-shaped opening when said gown bin is mounted on said back surface of said front member; and
said gown bin comprises a vertical opening formed in a front surface thereof, said vertical opening substantially aligned with said vertical portion of said T-shaped opening when said gown bin is mounted on said back surface of said front member.
